(19) United States
(12) Patent Application Publication
(10) Pub. No.: US 2006/0271706 A1
(43) Pub. Date: Nov. 30, 2006

(54) Method, apparatus, and computer program product for requesting deterministic virtual address identifiers for nodes in a fibre channel network

(76) Inventors: Robert J. Dugan, Hyde Park, NY (US); Giles Roger Frazier, Austin, TX (US)

Correspondence Address: IBM CORP (YA);C/O YEE & ASSOCIATES PC, P.O. BOX 802333, DALLAS, TX, 75380, US

(21) Appl. No.: 11/136,655

(22) Filed: May 24, 2005

(51) Int. Cl. G06F 15/16

(52) U.S. Cl. 709/245; 370/395.3

(57) ABSTRACT

A method, apparatus, and computer program product are disclosed for requesting deterministic virtual address identifiers for a node. The communications network includes a communications network fabric that couples nodes together. One of the nodes requests an assignment by the fabric of a particular value for a first node address identifier to be assigned to the node. The node then requests an assignment of a virtual node address identifier to be assigned to the node. The fabric assigns to the node a value for the virtual node address identifier that is deterministic and predictable by the node before the value is assigned.

### BACKGROUND OF THE INVENTION

1. Field of the Invention

The present invention is directed to data processing systems. More specifically, the present invention is directed to a method, apparatus, and computer program product for requesting deterministic virtual address identifiers for nodes in a Fibre Channel network.

2. Description of the Related Art

Fibre Channel is a high performance serial interconnect standard designed for bi-directional, point-to-point communications between nodes such as servers, storage systems, workstations, switches, and hubs. It offers a variety of benefits over other link-level protocols, including efficiency and high performance, scalability, simplicity, ease of use and installation, and support for popular upper-level protocols.

Fibre channel employs a topology known as a “fabric” to establish connections (paths) between ports. A fabric is a network of switches for interconnecting a plurality of devices without restriction as to the manner in which the switches can be arranged. A fabric can include a mixture of point-to-point, circuit switched, and arbitrated loop topologies.

In Fibre channel, a path is established between two nodes where the path's primary task is to transport network packets from one point to another at high speed with low latency, performing only simple error correction in hardware. The fibre channel switch provides flexible circuit/packet switched topology by establishing multiple simultaneous point-to-point connections. Because these connections are managed by the switches or “fabric elements” rather than the connected end devices or “end nodes”, fabric traffic management is greatly simplified from the perspective of the device.

Each node is coupled to the fabric utilizing a port included in the node. The node's port, referred to as an “N_Port”, is coupled to a port in the fabric, referred to as an “F_Port”, using a Fibre Channel communications link. Each N_Port has an address identifier, i.e. N_Port identifier (ID), that is assigned to that N_Port. This N_Port ID is used by the various nodes and the fabric to uniquely address the particular N_Port to which the N_Port ID is assigned.

The first N_Port ID that the fabric assigns to an N_Port may either be chosen by the fabric without input from the N_Port or may be requested by the N_Port. There are occasions when an N_Port needs to obtain a particular value for its first N_Port ID.

In addition to being able to request a particular N_Port ID for its first N_Port ID, an N_Port is also permitted to request an N_Port ID for its first N_Port ID that has a particular value for only its lower order bits. In this case, the fabric chooses a value for the upper order bits while the value of the lower order bits is chosen by the N_Port.

In some cases, an N_Port may need to be able to select a particular value to be assigned as its first N_Port ID. In other cases, an N_Port may need to be able to select only the lower order bits to be assigned as part of its first N_Port ID. For example, an application that accesses the N_Port may have a preconfigured “hard address” that the application will use when addressing the N_Port. In this case, the actual N_Port ID that is assigned to the N_Port must match the N_Port ID that the application believes is assigned to the N_Port.

Fibre Channel has the ability to assign more than one N_Port ID to a single N_Port. These additional N_Port IDs are virtual N_Port IDs for that N_Port. The first N_Port ID that is assigned to an N_Port is not a virtual N_Port ID.

A problem can arise when additional, virtual, N_Port IDs are needed for an N_Port. Currently, Fibre Channel permits an N_Port to request a particular value for only the first N_Port ID that is assigned to an N_Port. The values for any additional, i.e. virtual, N_Port IDs that are assigned to an N_Port are chosen only by the fabric. The N_Port is not permitted to request a particular value for any or part of any virtual N_Port ID.

An N_Port may need to be able to select a particular value for a first N_Port ID and additional, virtual N_Port IDs assigned to that single N_Port where the values for all N_Port IDs, both the first and all subsequent virtual N_Port IDs, assigned to that N_Port are selected by the N_Port and not by the fabric. The prior art permits an N_Port to select a particular value for only its first N_Port ID. According to the prior art, the additional, virtual, N_Port IDs are not deterministic or predictable from the N_Port's point of view. The values for the additional, virtual, N_Port IDs are randomly assigned from the N_Port's point of view. There is no means by which the N_Port can request a specific, particular, N_Port ID for an additional N_Port ID or be able to predict the value that the fabric will choose for an additional N_Port ID.

Just as it is advantageous for an N_Port to be able to request a specific, particular N_Port ID for its first N_Port ID, it is likewise advantageous for the N_Port to be able to request specific values for its additional N_Port IDs. Being able to request a specific value for a virtual N_Port ID is critical in an environment where a virtual N_Port ID has been preconfigured to be a particular value.

An example of such an environment is a protocol converter in which the N_Port IDs that are assigned to a particular N_Port need to be equal to the N_Port IDs that have been preconfigured into an I/O Configuration Dataset (IOCDS) in a host computer system or a native FC-SB-3 application in which a control unit acquires multiple N_Port IDs for a single N_Port.

One method for obtaining predictable additional N_Port IDs would be to preconfigure the fabric to assign particular virtual N_Port IDs to a particular N_Port. For example, in order to ensure that the fabric assigned particular values for virtual N_Port IDs for a particular N_Port, the user could manually preconfigure particular values for all of the virtual N_Port IDs into the fabric, and put the fabric into a mode in which it would assign these particular values as the virtual N_Port IDs. However, such a configuration of the fabric is expensive, time consuming, and prone to errors.

Therefore, a need exists for a method, apparatus, and computer program product for requesting deterministic values for virtual address identifiers for nodes in a Fibre Channel network that completely eliminates the requirement that the fabric be preconfigured to use specific virtual address identifiers.

### SUMMARY OF THE INVENTION

A method, apparatus, and computer program product are disclosed for requesting deterministic virtual address identifiers for a node. The communications network includes a communications network fabric that couples nodes together. One of the nodes requests an assignment by the fabric of a particular value for a first node address identifier to be assigned to the node. The node then requests an assignment of a virtual node address identifier to be assigned to the node. The fabric assigns to the node a value for the virtual node address identifier that is deterministic and predictable by the node before the value is assigned.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a storage area network that includes multiple nodes that are coupled together utilizing a fabric in accordance with the present invention;

FIG. 2 is a block diagram of a data processing system that may be used to implement any of the data processing systems of FIG. 1 in accordance with the present invention;

FIG. 3A illustrates a high level flow chart that depicts a node requesting a particular node identifier and additional virtual node identifiers in accordance with the prior art;

FIG. 3B depicts a high level flow chart that depicts the fabric granting a particular node identifier to a node in response to a request, such as depicted by FIG. 3A, and additional non-deterministic virtual node identifiers in accordance with the prior art;

FIG. 4 illustrates a high level flow chart that depicts a node requesting a particular node identifier and additional deterministic virtual node identifiers in accordance with the present invention;

FIG. 5 depicts a high level flow chart that depicts the fabric granting a particular node identifier to a node in response to a request, such as depicted by FIG. 4, and additional deterministic virtual node identifiers in accordance with the present invention;

FIG. 6A illustrates a high level flow chart that depicts a node requesting a node identifier having particular bits and additional virtual node identifiers in accordance with the prior art;

FIG. 6B depicts a high level flow chart that depicts the fabric granting a node identifier that has particular bits to a node in response to a request, such as depicted by FIG. 6A, and additional non-deterministic virtual node identifiers in accordance with the prior art;

FIG. 7 illustrates a high level flow chart that depicts a node requesting a node identifier having particular bits and additional deterministic virtual node identifiers in accordance with the present invention;

FIG. 8 depicts a high level flow chart that depicts the fabric granting a node identifier that has particular bits to a node in response to a request, such as depicted by FIG. 7, and additional deterministic virtual node identifiers in accordance with the present invention;

FIG. 9 illustrates a high level flow chart that depicts a node requesting a particular node identifier and N number of additional deterministic virtual node identifiers in accordance with the present invention; and

FIG. 10 depicts a high level flow chart that depicts the fabric granting a particular node identifier in response to a request, such as depicted by FIG. 9, and N number of additional deterministic virtual node identifiers in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a method, apparatus, and computer program product for permitting a node to request particular values for its first and virtual N_Port IDs. Thus, the present invention provides deterministic virtual address identifiers for nodes in a Fibre Channel network.

As used herein, the term “virtual” means N_Port IDs that are assigned to a particular N_Port after the assignment of the first N_Port ID to that N_Port. Thus, virtual N_Port IDs are the second through an nth N_Port ID assigned to a particular N_Port.

The virtual N_Port IDs that the fabric assigns according to the present invention are deterministic. Therefore, the datasets in a host, such as an IOCDS dataset described above for example, can be preconfigured at the host where virtual N_Port IDs are set to predetermined values selected by the N_Port prior to the actual assignment of virtual N_Port IDs.

The present invention provides a method, apparatus, and product for modifying the fabric so that it will assign deterministic and predictable virtual N_Port IDs. An N_Port invokes the present invention to cause the fabric to assign deterministic and predictable N_Port IDs by requesting a particular value for all or part of the first N_Port ID to be assigned to that N_Port. Thereafter, the fabric will assign deterministic and predictable values for virtual N_Port IDs to that N_Port. According to a first embodiment, the fabric will assign additional N_Port IDs consecutively from one plus a value specified by the requesting N_Port.

Alternatively, according to a second embodiment, the fabric will assign additional N_Port IDs starting at one plus an N_Port ID value having lower order bits specified by the N_Port and upper order bits originally selected by the fabric.

According to a third embodiment, the present invention permits the N_Port to request an N number of virtual N_Port IDs. The fabric then reserves this N number of virtual N_Port IDs prior to the N_Port requesting any virtual N_Port IDs. When the fabric reserves N_Port IDs for a particular N_Port, it does not assign them to any N_Port connected to the fabric other than the N_Port for which they are reserved.

In each embodiment, the present invention is invoked when an N_Port requests a particular N_Port ID value for its first, non-virtual, N_Port ID. This particular value may be either the entire N_Port ID value or may be only the lower order bits of the N_Port ID. The N_Port requests a particular N_Port ID by transmitting a fabric login (FLOGI) request that has a non-zero value in its source identifier. By transmitting an FLOGI request having a non-zero source identifier, an N_Port can invoke the present invention and receive deterministic, predictable values for its virtual N_Port IDs.

According to the first embodiment, the N_Port will first request the assignment of a specific N_Port ID. This is the first N_Port ID that will be assigned to this N_Port. Therefore, this N_Port ID is not a virtual N_Port ID.

The N_Port sets the source identifier in a fabric login (FLOGI) request equal to a value that is the particular N_Port ID value that the N_Port wants to have assigned to it. In response, if the fabric is able to assign that particular N_Port ID, it will assign the requested N_Port ID to that particular N_Port as the first N_Port ID for the N_Port.

This same N_Port may then request the assignment of additional, virtual, N_Port IDs. In order to request additional N_Port IDs, the N_Port will transmit a fabric discovery (FDISC) request to the fabric. When sending an FDISC request for additional N_Port IDs, the Fibre Channel standard requires that the source identifier in the FDISC request be set to zero. Setting the source identifier to a value other than zero would give the FDISC request a different meaning. An FDISC request having its source identifier set to a value other than zero would not result in the fabric assigning additional N_Port IDs to the N_Port that sent the request.

In response to the fabric receiving an FDISC request having a source identifier set to zero, the fabric will assign an additional N_Port ID to the requesting N_Port. The N_Port ID that is assigned by the fabric is the value of the last N_Port ID that was assigned to this N_Port plus one. Thereafter, each time the fabric receives an FDISC request with a source identifier equal to zero from that N_Port, the fabric will assign an N_Port ID that has a value that is equal to the value of the last N_Port ID plus one. Thus, the values of the N_Port IDs that are assigned to an N_Port are consecutive. They are predictable and deterministic from the N_Port's perspective.

The N_Port can request a particular first N_Port ID value according to the prior art. Thereafter, according to the present invention, the values of additional, virtual, N_Port IDs that are assigned to this N_Port are predictable. Therefore, an application or operating system that uses this N_Port will be able to set preconfigured N_Port IDs prior to the N_Port requesting the fabric to assign virtual N_Port IDs.

According to the second embodiment, an N_Port can request specific lower order bit values according to the prior art. In this embodiment, the fabric is able to choose the upper order bit values. Thus, the first N_Port ID that is assigned to the N_Port will be equal to an N_Port ID that has its upper order bits chosen by the fabric and the lower order bits specified by the N_Port.

Thereafter, according to the present invention and similarly to the first embodiment, the values of the additional, virtual, N_Port IDs that are assigned to this N_Port are also predictable. In response to the fabric receiving an FDISC request according to the second embodiment, the fabric will assign an additional N_Port ID to the requesting N_Port. The N_Port ID that is assigned by the fabric is the value of the last N_Port ID that was assigned to this N_Port plus one. In this case the value of the first N_Port ID that was assigned to the N_Port had its upper order bits selected by the fabric and lower order bits selected by the N_Port. Thereafter, each time the fabric receives an FDISC request from that N_Port, the fabric will assign an N_Port ID that has a value that is equal to the value of the last N_Port ID plus one. Thus, the N_Port IDs that are assigned to an N_Port are consecutive. They are predictable and deterministic from the N_Port's perspective.

According to the third embodiment, an additional bit is included in the FLOGI request. This FLOGI request requests a particular value for the first N_Port ID. The value of the additional bit indicates a number, “N”. This number N is the number of virtual N_Port IDs that the N_Port will be requesting. According to this embodiment, the fabric would not assign the first, non-virtual, requested N_Port ID unless the fabric is also going to be able to assign N additional virtual N_Port IDs that are deterministic and consecutive from the value of the first requested N_Port ID.

Since the fabric would not assign any N_Port IDs unless it had enough resources to assign the required number of virtual N_Port IDs, the time-consuming process of acquiring a few N_Port IDs only to determine later that not enough N_Port IDs could be obtained is eliminated.

If the N_Port does not need deterministic N_Port IDs, the N_Port will send the first request for an N_Port ID, i.e. an FLOGI request, having its source identifier equal to zero. Thereafter when the fabric receives FDISC requests for additional N_Port IDs, the fabric will choose values for each additional N_Port ID assigned to the N_Port. In this case, the N_Port cannot predict in advance what value will be assigned to it as a virtual N_Port ID.

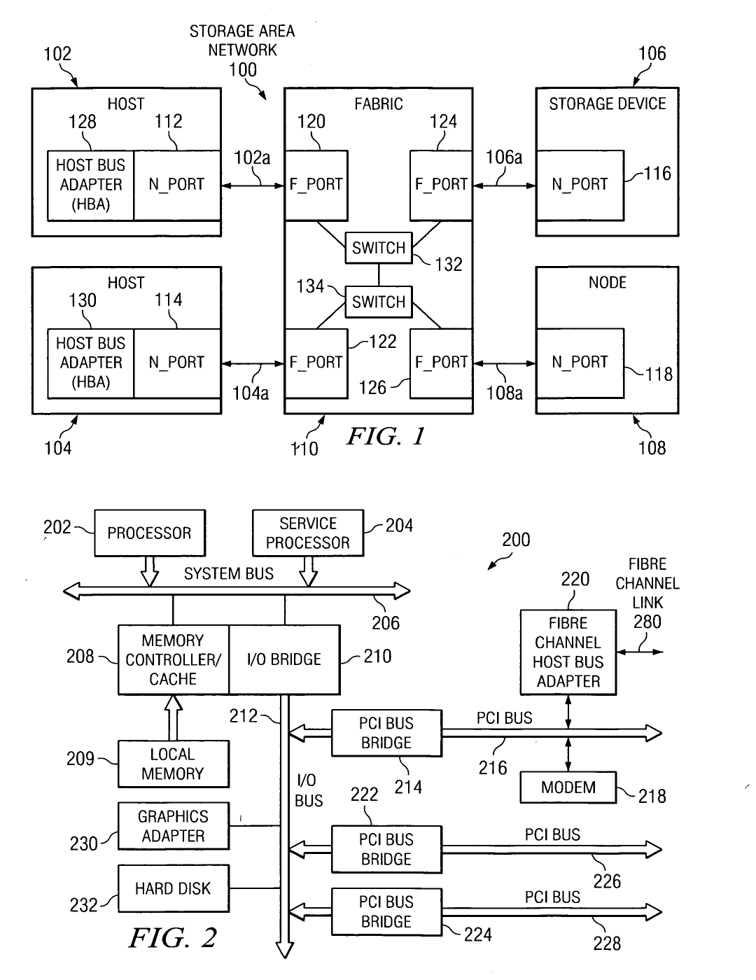

Prior to describing the present invention in detail, the background of a computing environment that includes the present invention is described with reference to FIGS. 1 and 2.

FIG. 1 is a block diagram of a storage area network that includes multiple nodes that are coupled together utilizing a fabric in accordance with the present invention. FIG. 1 depicts a storage area network (SAN) 100 in accordance with the present invention. SAN 100 includes multiple end nodes, such as host 102, host 104, storage device 106, and node 108. Each end node is coupled to fabric 100 utilizing a Fibre Channel link. For example, host 102 is coupled to fabric 110 utilizing link 102a. Host 104 is coupled to fabric 110 utilizing link 104a; storage device 106 is coupled to fabric 110 utilizing link 106a; and node 108 is coupled to fabric 110 utilizing link 108a.

Each node is coupled to its Fibre Channel link through a Fibre Channel port, i.e. an N_Port, included in the node. Node 102 includes N_Port 112. Node 104 includes N_Port 114. Node 106 includes N_Port 116. Node 108 includes N_Port 118.

As depicted, nodes 102 and 104 are hosts, and node 106 is a storage device.

Fabric 110 includes a Fibre Channel port, i.e. an F_Port, for each node. Thus, a node is coupled to the fabric by coupling an N_Port in the node to an F_Port in the fabric utilizing a Fibre Channel communications link.

N_Port 112 in node 102 is coupled to F_Port 120 in fabric 110 utilizing Fibre Channel communications link 102a. N_Port 114 in node 104 is coupled to F_Port 122 in fabric 110 utilizing Fibre Channel communications link 104a. N_Port 116 in node 106 is coupled to F_Port 124 in fabric 110 utilizing Fibre Channel communications link 106a. N_Port 118 in node 108 is coupled to F_Port 126 in fabric 110 utilizing Fibre Channel communications link 108a.

Each host includes a Host Bus Adapter (HBA). HBA 128 communicates with fabric 110 through N_Port 112, communications link 102a, and F_Port 120; HBA 130 communicates with fabric 110 through N_Port 114, communications link 104a, and F_Port 122.

Storage device 106 communicates with fabric 110 through N_Port 116, communications link 106a, and F_Port 124.

Node 108 communicates with fabric 110 through N_Port 118, communications link 106a, and F_Port 126.

Fabric 110 includes one or more switches, such as switches 132 and 134, for switching network packets through fabric 110.

FIG. 2 is a block diagram of a data processing system that may be used to implement any of the data processing systems of FIG. 1 in accordance with the present invention. Data processing system 200 may be a symmetric multiprocessor (SMP) system including a plurality of processors 202 and 204 connected to system bus 206. Alternatively, a single processor system may be employed. In the depicted example, processor 204 is a service processor. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of I/O adapters, such as modems 218 may be connected to PCI bus 216. Typical PCI bus implementations will support four PCI expansion slots or add-in connectors. Communications links to network computers 112 and 116 in FIG. 1 may be provided through modem 218 and Fibre channel host bus adapter 220 connected to PCI local bus 216 through add-in boards.

Host Bus Adapter (HBA) 220 enables data processing system 200 to send and receive message from fabric 110 via a Fibre Channel link 280.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

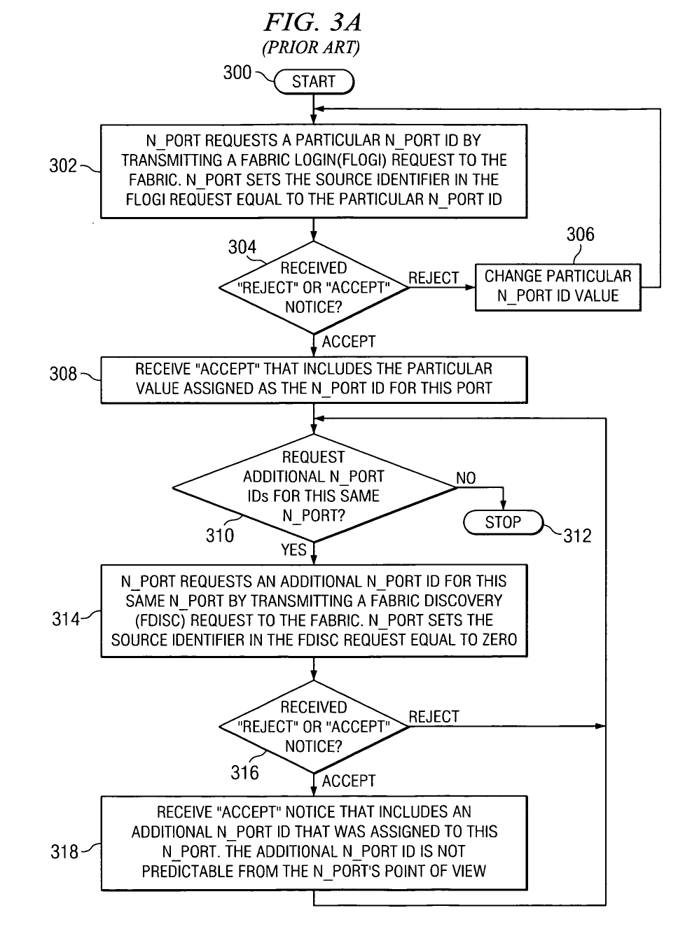

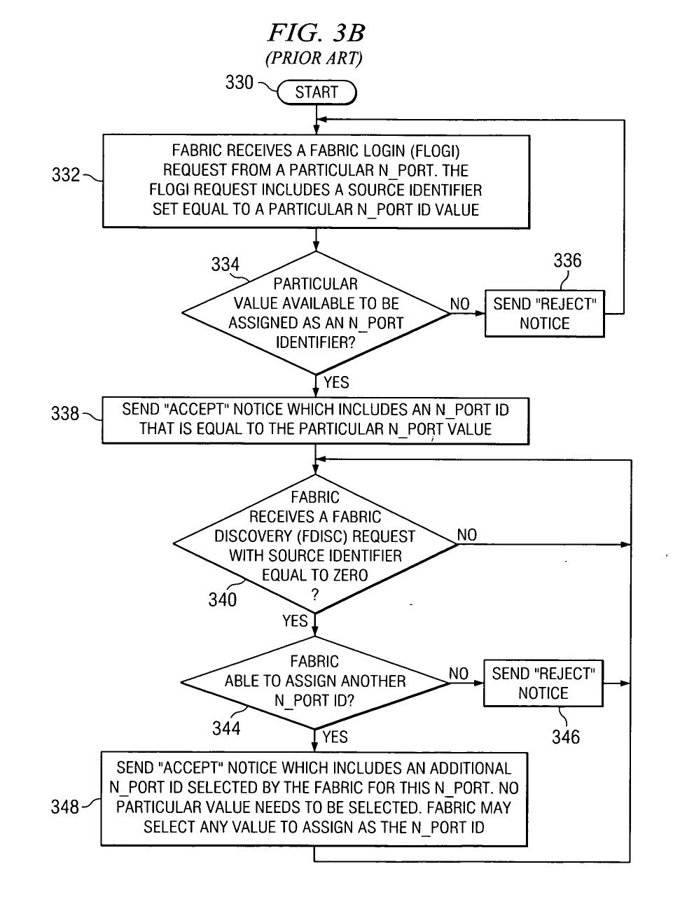

FIG. 3A illustrates a high level flow chart that depicts a node requesting a particular node identifier and additional virtual node identifiers in accordance with the prior art. The process starts as depicted by block 300 and thereafter passes to block 302 which illustrates an N_Port in a node requesting a particular N_Port identifier (ID) by transmitting a fabric login (FLOGI) request to the fabric. The N_Port sets the source identifier in the FLOGI request equal to the particular N_Port ID that the N_Port is requesting.

Next, block 304 depicts a determination of whether or not the N_Port has received either a “reject” or “accept” notice from the fabric. If a determination is made that the N_Port has received a reject notice, the process passes to block 306 which illustrates the N_Port changing the particular N_Port value that the N_Port is requesting. The process then passes back to block 302.

Referring again to block 304, if a determination is made that the N_Port has received an accept notice, the process passes to block 308 which depicts the N_Port receiving an accept notice that includes an N_Port ID. This N_Port ID is the particular value that was requested by the N_Port.

Thereafter, block 310 illustrates a determination of whether or not the N_Port needs to request additional N_Port IDs for this same N_Port. Additional N_Port IDs would be virtual N_Port IDs for this N_Port. If a determination is made that this N_Port does not need to request additional N_Port IDs, the process terminates as illustrated by block 312.

Referring again to block 310, if a determination is made that this N_Port does need to request additional N_Port IDs, the process passes to block 314 which depicts the N_Port requesting an additional N_Port ID for this same N_Port. The N_Port makes this request by transmitting a fabric discovery (FDISC) request to the fabric. The N_Port sets the source identifier in the FDISC request equal to zero.

Next, block 316 illustrates the N_Port receiving either a reject or accept notice in response to that FDISC request. If a determination is made that the N_Port received a reject request, the process passes to block 310. Referring again to block 316, if a determination is made that the N_Port received an accept request, the process passes to block 318 which depicts the N_Port receiving an accept notice that includes an additional N_Port ID that was assigned by the fabric to this N_Port. The value of the additional N_Port ID is selected by the fabric and is not predictable from the N_Port's point of view. The process then passes to block 310.

FIG. 3B depicts a high level flow chart that depicts the fabric granting a particular node identifier to a node in response to a request, such as depicted by FIG. 3A, and additional non-deterministic virtual node identifiers in accordance with the prior art. The process starts as depicted by block 330 and thereafter passes to block 332 which depicts the fabric receiving a fabric login request (FLOGI) from a particular N_Port. The FLOGI request includes a source identifier that is set equal to a particular N_Port ID value.

Next, block 334 illustrates a determination of whether or not the particular value indicated by the source identifier is available to be assigned as an N_Port ID. If a determination is made that the particular value indicated by the source identifier is not available to be assigned as an N_Port ID, the process passes to block 336 which depicts sending a “reject” notice. The process then passes back to block 332.

Referring again to block 334, if a determination is made that the particular value indicated by the source identifier is available to be assigned as an N_Port ID, the process passes to block 338 which illustrates sending an “accept” notice that includes an N_Port ID that is equal to the particular N_Port value.

Next, block 340 illustrates a determination of whether or not the fabric has received a fabric discovery (FDISC) request having a source identifier set equal to zero. If a determination is made that the fabric has not received a fabric discovery (FDISC) request with its source identifier equal to zero, the process passes back to block 340. Referring again to block 340, if a determination is made that the fabric has received a fabric discovery (FDISC) request with its source identifier equal to zero, the process passes to block 344 which depicts a determination of whether or not the fabric is able to assign another N_Port ID to this N_Port. If a determination is made that the fabric is not able to assign another N_Port ID to this N_Port, the process passes to b block 346 which illustrates sending a reject notice. The process then passes back to block 340.

Referring again to block 344, if a determination is made that the fabric is able to assign another N_Port ID to this N_Port, the process passes to block 348 which illustrates the fabric sending an “accept” notice. The accept notice includes an additional N_Port ID that was selected by the fabric to be assigned to this N_Port. The fabric is permitted to select any available N_Port ID. No particular value must be selected. Thus, the value selected by the fabric is not deterministic from the N_Port's perspective. The process then passes back to block 340.

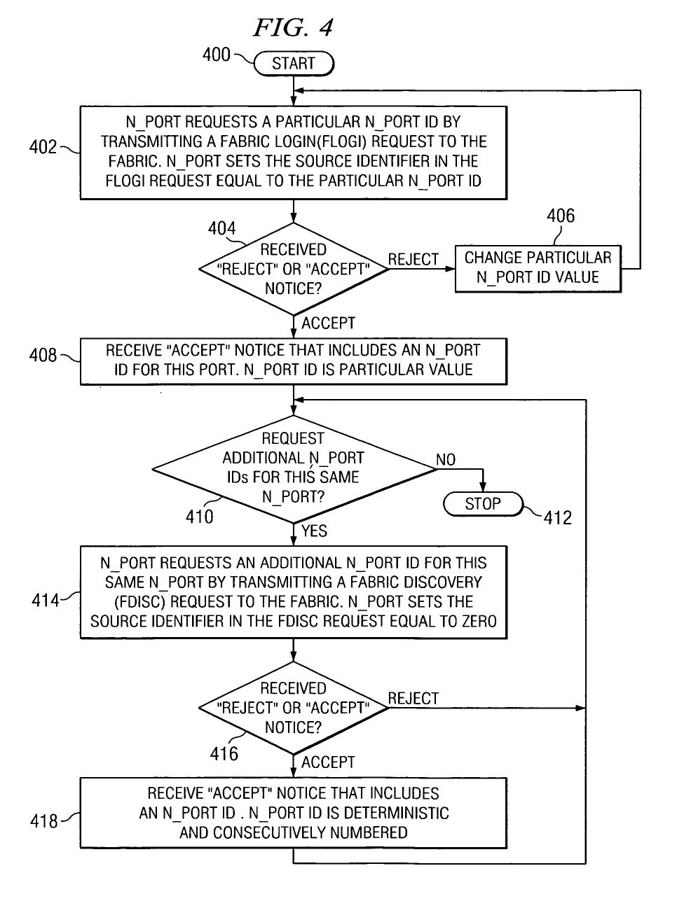

FIG. 4 illustrates a high level flow chart that depicts a node requesting a particular node identifier and additional deterministic virtual node identifiers in accordance with the present invention. The process starts as depicted by block 400 and thereafter passes to block 402 which illustrates an N_Port in a node requesting a particular value for its first N_Port identifier (ID) by transmitting a fabric login (FLOGI) request to the fabric. The N_Port sets the source identifier in the FLOGI request equal to the particular value that the N_Port is requesting to be assigned as its N_Port ID.

Next, block 404 depicts a determination of whether or not the N_Port has received either a “reject” or “accept” notice from the fabric. If a determination is made that the N_Port has received a reject notice, the process passes to block 406 which illustrates the N_Port changing the particular N_Port value that the N_Port is requesting. The process then passes back to block 402.

Referring again to block 404, if a determination is made that the N_Port has received an accept notice, the process passes to block 408 which depicts the N_Port receiving an accept notice that includes an N_Port ID. This N_Port ID is the particular value that was requested by the N_Port.

Thereafter, block 410 illustrates a determination of whether or not the N_Port needs to request additional N_Port IDs for this same N_Port. Additional N_Port IDs would be virtual N_Port IDs for this N_Port. If a determination is made that this N_Port does not need to request additional N_Port IDs, the process terminates as illustrated by block 412.

Referring again to block 410, if a determination is made that this N_Port does need to request additional N_Port IDs, the process passes to block 414 which depicts the N_Port requesting an additional N_Port ID for this same N_Port. The N_Port makes this request by transmitting a fabric discovery (FDISC) request to the fabric. The N_Port sets the source identifier in the FDISC request equal to zero.

Next, block 416 illustrates the N_Port receiving either a reject or accept notice in response to that FDISC request. If a determination is made that the N_Port received a reject request, the process passes to block 410. If after repeated rejects are received, the N_Port could exit the process and then later, after a delay, re-enter the process at block 410. Referring again to block 416, if a determination is made that the N_Port received an accept request, the process passes to block 418 which depicts the N_Port receiving an accept notice that includes an additional N_Port ID that was assigned by the fabric. The additional N_Port ID assigned by the fabric is deterministic from the N_Port's point of view. The value of the additional N_Port assigned by the fabric is equal to the value of the last N_Port ID that was assigned to this N_Port plus one. The process then passes to block 410.

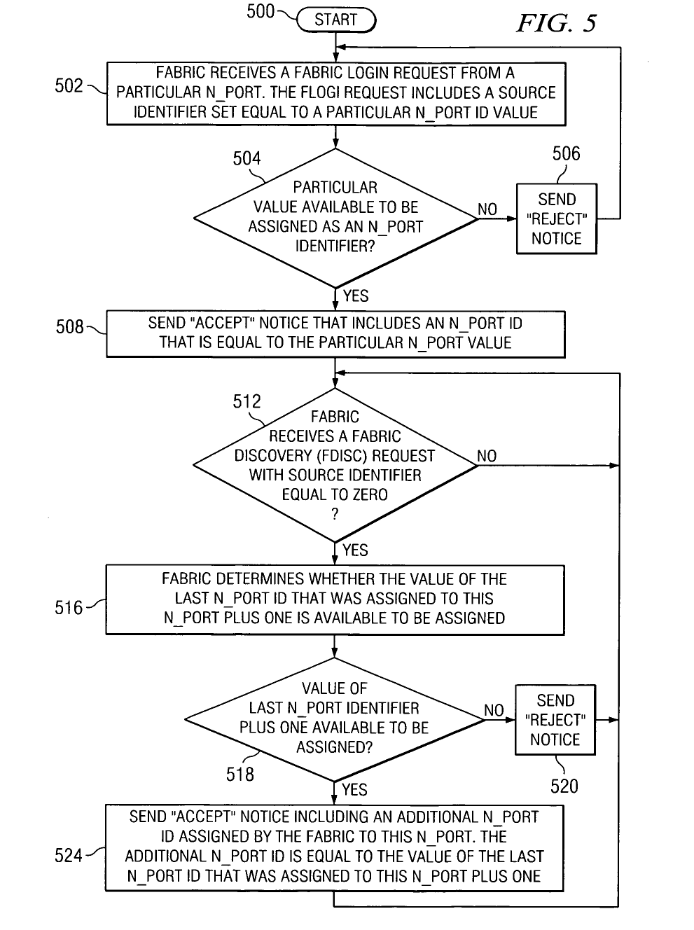

FIG. 5 depicts a high level flow chart that depicts the fabric granting a particular node identifier to a node in response to a request, such as depicted by FIG. 4, and additional deterministic virtual node identifiers in accordance with the present invention. The process starts as depicted by block 500 and thereafter passes to block 502 which depicts the fabric receiving a fabric login request (FLOGI) from a particular N_Port. The FLOGI request includes a source identifier that is set equal to a particular N_Port ID value.

Next, block 504 illustrates a determination of whether or not the particular value indicated by the source identifier is available to be assigned as an N_Port ID. If a determination is made that the particular value indicated by the source identifier is not available to be assigned as an N_Port ID, the process passes to block 506 which depicts sending a “reject” notice. The process then passes back to block 502.

Referring again to block 504, if a determination is made that the particular value indicated by the source identifier is available to be assigned as an N_Port ID, the process passes to block 508 which illustrates sending an “accept” notice that includes an N_Port ID that has a value that is equal to the particular N_Port value.

Next, block 512 illustrates a determination of whether or not the fabric has received a fabric discovery (FDISC) request having a source identifier set equal to zero. If a determination is made that the fabric has not received a fabric discovery (FDISC) request with its source identifier equal to zero, the process passes back to block 512. Referring again to block 512, if a determination is made that the fabric has received a fabric discovery (FDISC) request with its source identifier equal to zero, the process passes to block 516 which depicts the fabric determining whether the value of the last N_Port ID that was assigned to this N_Port plus one is available to be assigned as another N_Port ID.

Block 518, then, illustrates a determination of whether or not the fabric is able to assign as an N_Port ID value the last value of the N_Port ID plus one as an additional N_Port ID to this N_Port. If a determination is made that the fabric is not able to assign as a value the last value of the N_Port ID plus one as another N_Port ID to this N_Port, the process passes to block 520 which depicts the fabric sending a reject notice. The process then passes back to block 512. Referring again to block 518, if a determination is made that the fabric is able to assign as a value the last value of the N_Port ID plus one as another N_Port ID to this N_Port, the process passes to block 524 which illustrates the fabric sending an “accept” notice. The accept notice includes an additional N_Port ID that has a value that is equal to the last N_Port ID value assigned to this N_Port plus one. The process then passes back to block 512.

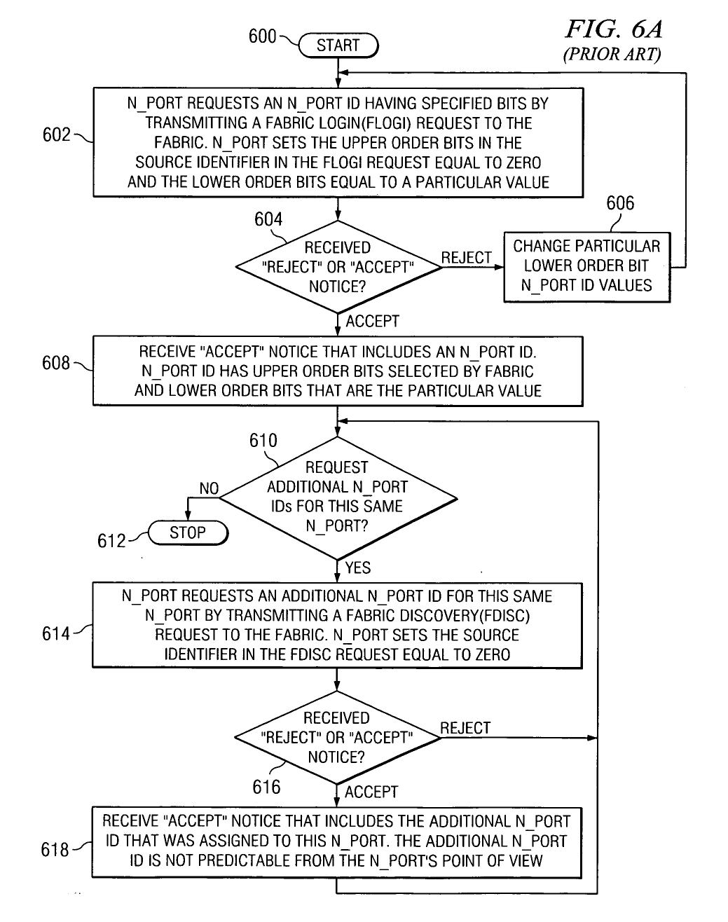

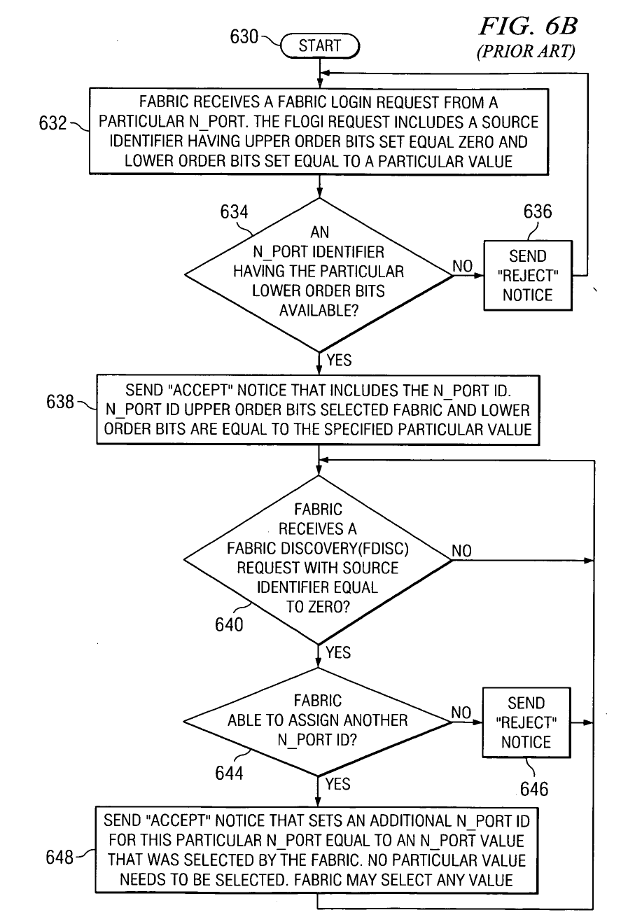

FIG. 6A illustrates a high level flow chart that depicts a node requesting a node identifier having particular bits and additional virtual node identifiers in accordance with the prior art. The process starts as depicted by block 600 and thereafter passes to block 602 which illustrates an N_Port in a node requesting a value for its first N_Port identifier (ID) that has particular bits by transmitting a fabric login (FLOGI) request to the fabric that includes a source identifier that has the upper order bits set equal to zero and the lower order bits set equal to the particular bits. In this manner, the N_Port can specify a portion of the N_Port ID that it is requesting. The N_Port does not specify the upper order bits. The N_Port only specifies a particular value for the lower order bits.

Next, block 604 depicts a determination of whether or not the N_Port has received either a “reject” or “accept” notice from the fabric. If a determination is made that the N_Port has received a reject notice, the process passes to block 606 which illustrates the N_Port changing the value of the lower order bits that the N_Port is requesting. The process then passes back to block 602.

Referring again to block 604, if a determination is made that the N_Port has received an accept notice, the process passes to block 608 which depicts the N_Port receiving an accept notice that includes an N_Port ID. This N_Port ID has its upper order bits selected by the fabric and the lower order bits that were specified by the N_Port as the particular lower order bit value.

Thereafter, block 610 illustrates a determination of whether or not the N_Port needs to request additional N_Port IDs for this same N_Port. Additional N_Port IDs would be virtual N_Port IDs for this N_Port. If a determination is made that this N_Port does not need to request additional N_Port IDs, the process terminates as illustrated by block 612.

Referring again to block 610, if a determination is made that this N_Port does need to request additional N_Port IDs, the process passes to block 614 which depicts the N_Port requesting an additional N_Port ID for this same N_Port. The N_Port makes this request by transmitting a fabric discovery (FDISC) request to the fabric. The N_Port sets the source identifier in the FDISC request equal to zero.

Next, block 616 illustrates the N_Port receiving either a reject or accept notice in response to that FDISC request. If a determination is made that the N_Port received a reject request, the process passes to block 610. If after repeated rejects are received, the N_Port could exit the process and then later, after a delay, re-enter the process at block 610. Referring again to block 616, if a determination is made that the N_Port received an accept request, the process passes to block 618 which depicts the N_Port receiving an accept notice that includes an additional N_Port ID that was assigned by the fabric to this N_Port. The additional N_Port ID is selected by the fabric and is not predictable from the N_Port's point of view. The process then passes to block 610.

FIG. 6B depicts a high level flow chart that depicts the fabric granting a node identifier that has particular bits to a node in response to a request, such as depicted by FIG. 6A, and additional non-deterministic virtual node identifiers in accordance with the prior art. The process starts as depicted by block 630 and thereafter passes to block 632 which depicts the fabric receiving a fabric login request (FLOGI) from a particular N_Port. The upper order bits of the source identifier in the FLOGI request are set equal to zero and the lower order bits of the source identifier are set equal to a particular value.

Next, block 634 illustrates a determination of whether or not an N_Port ID is available that has the lower order bits of the N_Port ID equal to the particular value. If a determination is made that an N_Port ID is not available to be assigned that has the lower order bits of the N_Port ID equal to the particular value indicated by the lower order bits of the source identifier, the process passes to block 636 which depicts sending a “reject” notice. The process then passes back to block 632.

Referring again to block 634, if a determination is made that an N_Port ID is available to be assigned that has the lower order bits of the N_Port ID equal to the particular value indicated by the lower order bits of the source identifier, the process passes to block 638 which illustrates sending an “accept” notice that includes an N_Port ID. This N_Port ID value has its upper order bits selected by the fabric and the lower order bits equal to the particular value specified by the lower order bits of the source identifier in the FLOGI request.

Next, block 640 illustrates a determination of whether or not the fabric has received a fabric discovery (FDISC) request having a source identifier set equal to zero. If a determination is made that the fabric has not received a fabric discovery (FDISC) request with its source identifier equal to zero, the process passes back to block 640. Referring again to block 640, if a determination is made that the fabric has received a fabric discovery (FDISC) request with its source identifier equal to zero, the process passes to block 644 which depicts a determination of whether or not the fabric is able to assign another N_Port ID to this N_Port. If a determination is made that the fabric is not able to assign another N_Port ID to this N_Port, the process passes to block 646 which illustrates sending a reject notice. The process then passes back to block 640.

Referring again to block 644, if a determination is made that the fabric is able to assign another N_Port ID to this N_Port, the process passes to block 648 which illustrates the fabric sending an “accept” notice. The accept notice includes an additional N_Port ID that was selected by the fabric to be assigned to this N_Port. The fabric is permitted to select any available N_Port ID. No particular value must be selected. Thus, the value selected by the fabric is not deterministic from the N_Port's perspective. The process then passes back to block 640.

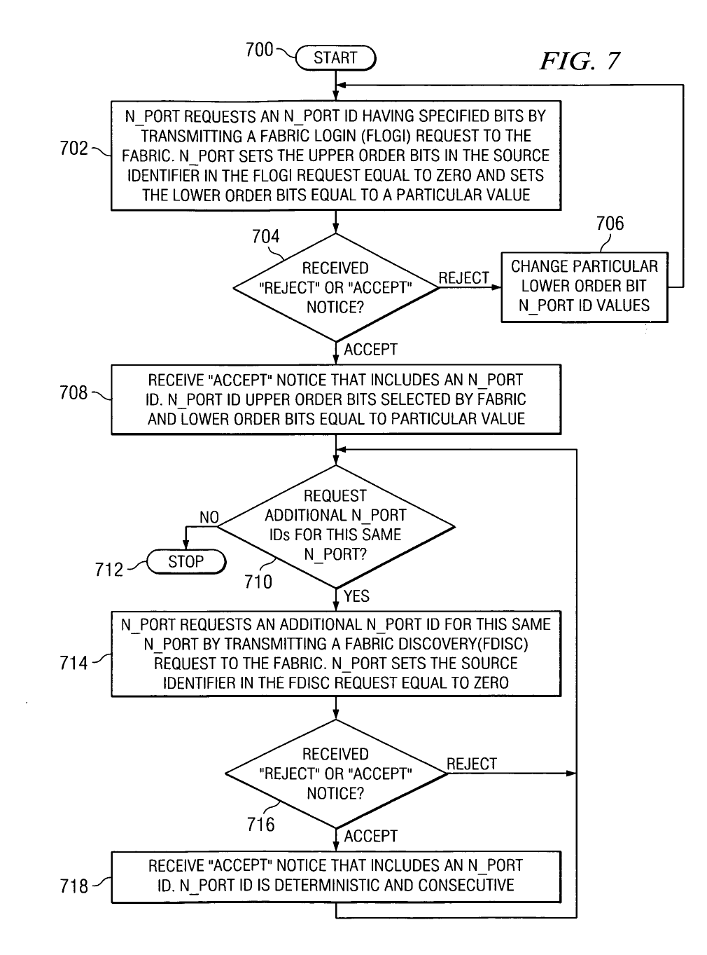

FIG. 7 illustrates a high level flow chart that depicts a node requesting a node identifier having particular bits and additional deterministic virtual node identifiers in accordance with the present invention. The process starts as depicted by block 700 and thereafter passes to block 702 which illustrates an N_Port in a node requesting a particular value for its first N_Port identifier (ID) by transmitting a fabric login (FLOGI) request to the fabric that includes a source identifier that has the upper order bits set equal to zero and the lower order bits set equal to particular bits that are specified by the N_Port. In this manner, the N_Port can specify a portion of the value of the first N_Port ID that it is requesting. The N_Port does not specify the upper order bits. The N_Port only specifies a particular value for the lower order bits.

Next, block 704 depicts a determination of whether or not the N_Port has received either a “reject” or “accept” notice from the fabric. If a determination is made that the N_Port has received a reject notice, the process passes to block 706 which illustrates the N_Port changing the value of the lower order bits that the N_Port is requesting. The process then passes back to block 702.

Referring again to block 704, if a determination is made that the N_Port has received an accept notice, the process passes to block 708 which depicts the N_Port receiving an accept notice that includes an N_Port ID. The value of this N_Port ID has its upper order bits selected by the fabric and the lower order bits that were specified by the N_Port as the particular lower order bit value.

Thereafter, block 710 illustrates a determination of whether or not the N_Port needs to request additional N_Port IDs for this same N_Port. Additional N_Port IDs would be virtual N_Port IDs for this N_Port. If a determination is made that this N_Port does not need to request additional N_Port IDs, the process terminates as illustrated by block 712.

Referring again to block 710, if a determination is made that this N_Port does need to request additional N_Port IDs, the process passes to block 714 which depicts the N_Port requesting an additional N_Port ID for this same N_Port. The N_Port makes this request by transmitting a fabric discovery (FDISC) request to the fabric. The N_Port sets the source identifier in the FDISC request equal to zero.

Next, block 716 illustrates the N_Port receiving either a reject or accept notice in response to that FDISC request. If a determination is made that the N_Port received a reject request, the process passes to block 710. Referring again to block 716, if a determination is made that the N_Port received an accept request, the process passes to block 718 which depicts the N_Port receiving an accept notice that includes an additional N_Port ID. The value of this additional N_Port ID is deterministic and consecutive from the last N_Port ID value that was assigned to this N_Port. The additional N_Port ID assigned by the fabric is deterministic from the N_Port's point of view. The value of the additional N_Port assigned by the fabric is equal to the value of the last N_Port ID that was assigned to this N_Port plus one. The process then passes to block 710.

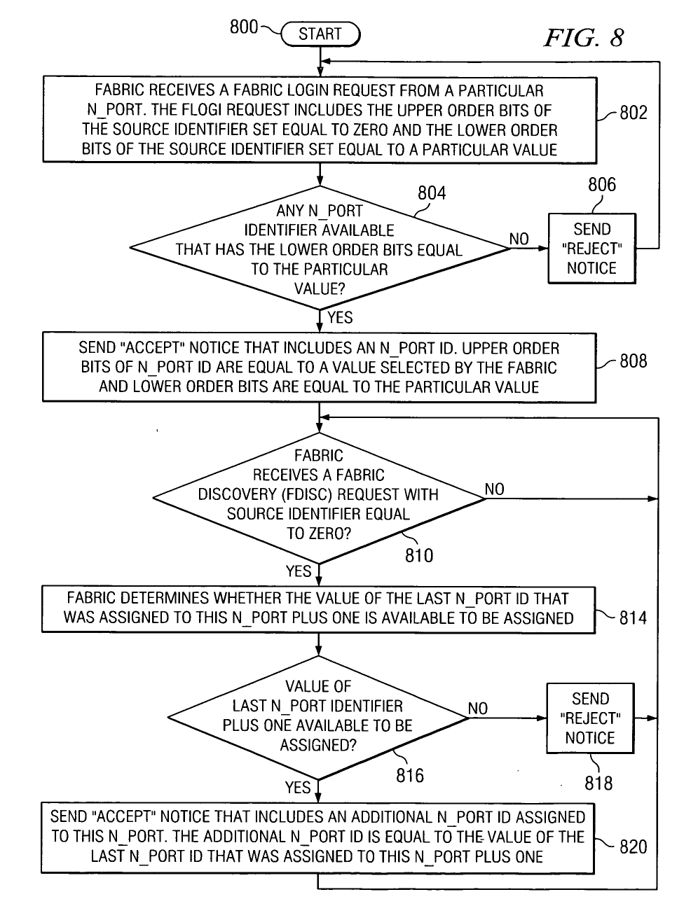

FIG. 8 depicts a high level flow chart that depicts the fabric granting a node identifier that has particular bits to a node in response to a request, such as depicted by FIG. 7, and additional deterministic virtual node identifiers in accordance with the present invention. The process starts as depicted by block 800 and thereafter passes to block 802 which depicts the fabric receiving a fabric login request (FLOGI) from a particular N_Port. The upper order bits of the source identifier in the FLOGI request are set equal to zero and the lower order bits of the source identifier are set equal to a particular value.

Next, block 804 illustrates a determination of whether or not an N_Port ID is available that has the lower order bits of the N_Port ID equal to the particular value. If a determination is made that an N_Port ID is not available to be assigned that has the lower order bits of the N_Port ID equal to the particular value indicated by the lower order bits of the source identifier, the process passes to block 806 which depicts sending a “reject” notice. The process then passes back to block 802.

Referring again to block 804, if a determination is made that an N_Port ID is available to be assigned that has the lower order bits of the N_Port ID equal to the particular value indicated by the lower order bits of the source identifier, the process passes to block 808 which illustrates sending an “accept” notice that includes an N_Port ID. This N_Port ID value has its upper order bits selected by the fabric and the lower order bits equal to the particular value specified by the lower order bits of the source identifier in the FLOGI request.

Next, block 810 illustrates a determination of whether or not the fabric has received a fabric discovery (FDISC) request having a source identifier set equal to zero. If a determination is made that the fabric has not received a fabric discovery (FDISC) request with its source identifier equal to zero, the process passes back to block 810. Referring again to block 810, if a determination is made that the fabric has received a fabric discovery (FDISC) request with its source identifier equal to zero, the process passes to block 814 which illustrates the fabric determining whether the value of the last N_Port ID that was assigned to the N_Port plus one is available to be assigned.

The process then passes to block 816 which depicts a determination of whether or not the fabric is able to assign another N_Port ID to this N_Port where the value of the N_Port ID is equal to the value of the last N_Port ID that was assigned to the N_Port plus one. If a determination is made that the fabric is not able to assign another N_Port ID to this N_Port where the value of the N_Port ID is equal to the value of the last N_Port ID that was assigned to the N_Port plus one, the process passes to block 818 which depicts sending a reject notice. The process then passes back to block 810.

Referring again to block 816, if a determination is made that the fabric is able to assign another N_Port ID to this N_Port, the process passes to block 820 which illustrates the fabric sending an “accept” notice. The accept notice includes an additional N_Port ID that was assigned to this N_Port. The value of the additional N_Port ID is equal to the value of the last N_Port ID that was assigned to this N_Port plus one. The process then passes back to block 810.

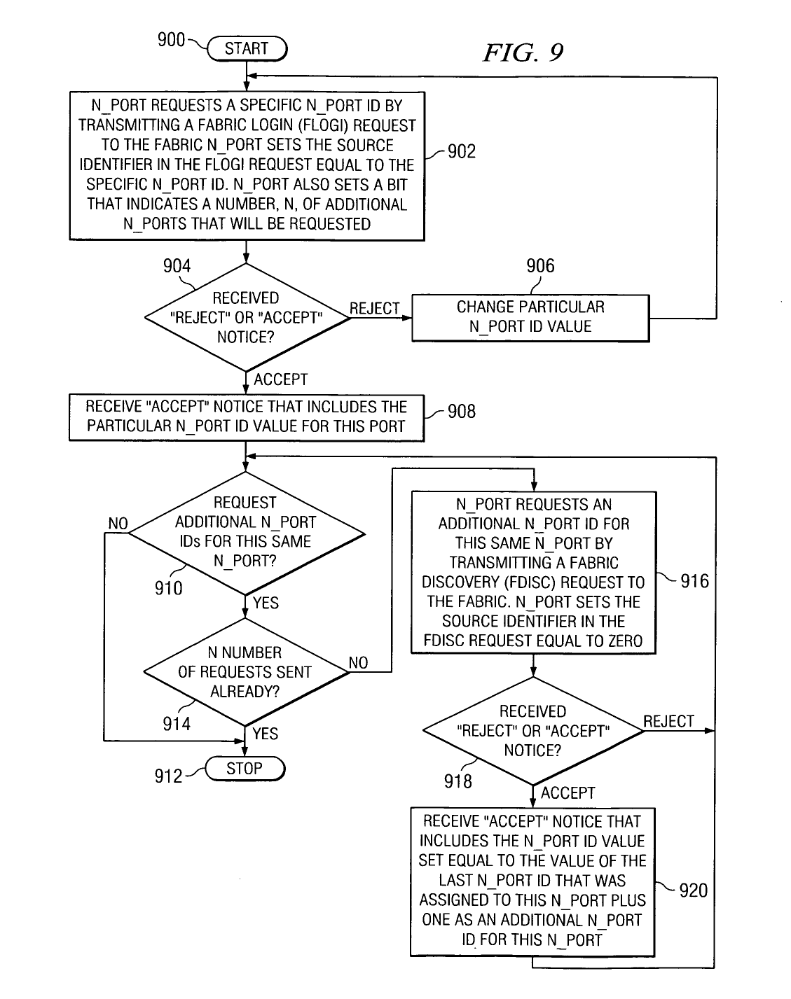

FIG. 9 illustrates a high level flow chart that depicts a node requesting a particular node identifier and N number of additional deterministic virtual node identifiers in accordance with the present invention.

The process starts as depicted by block 900 and thereafter passes to block 902 which illustrates an N_Port in a node requesting a particular value for its first N_Port identifier (ID) by transmitting a fabric login (FLOGI) request to the fabric. The N_Port sets the source identifier in the FLOGI request equal to the particular N_Port ID that the N_Port is requesting. The FLOGI request also includes a bit that is set to indicate a number “N”. The number “N” is the number of additional N_Port IDs that the N_Port is going to request. Thus, the N_Port will request N number of virtual N_Port IDs.

Next, block 904 depicts a determination of whether or not the N_Port has received either a “reject” or “accept” notice from the fabric. If a determination is made that the N_Port has received a reject notice, the process passes to block 906 which illustrates the N_Port changing the particular N_Port ID value that the N_Port is requesting. The process then passes back to block 902.

Referring again to block 904, if a determination is made that the N_Port has received an accept notice, the process passes to block 908 which depicts the N_Port receiving an accept notice that includes an N_Port ID. The value of this N_Port ID is the particular value that was requested by the N_Port.

Thereafter, block 910 illustrates a determination of whether or not the N_Port needs to request additional N_Port IDs for this same N_Port. Additional N_Port IDs would be virtual N_Port IDs for this N_Port. If a determination is made that this N_Port does not need to request additional N_Port IDs, the process terminates as illustrated by block 912.

Referring again to block 910, if a determination is made that this N_Port does need to request additional N_Port IDs, the process passes to block 914 which depicts a determination of whether or not N number of requests for virtual N_Port IDs have already been sent. If a determination is made that N number of requests for virtual N_Port IDs have already been sent, the process terminates as illustrated by block 912. Referring again to block 914, if a determination is made that N number of requests for virtual N_Port IDs have not already been sent, the process passes to block 916.

Block 916, then, illustrates the N_Port requesting an additional N_Port ID for this same N_Port. The N_Port makes this request by transmitting a fabric discovery (FDISC) request to the fabric. The N_Port sets the source identifier in the FDISC request equal to zero. Thereafter, block 918 depicts a determination of whether or not a reject or accept notice has been received. If a determination is made that a reject notice has been received, the process passes to block 910. Referring again to block 918, if a determination is made that an accept notice has been received, the process passes to block 920 which illustrates the N_Port receiving an accept notice that includes an additional N_Port ID. The value of the N_Port ID is equal to the value of the last N_Port ID that was assigned to this N_Port plus one. The process then passes to block 910.

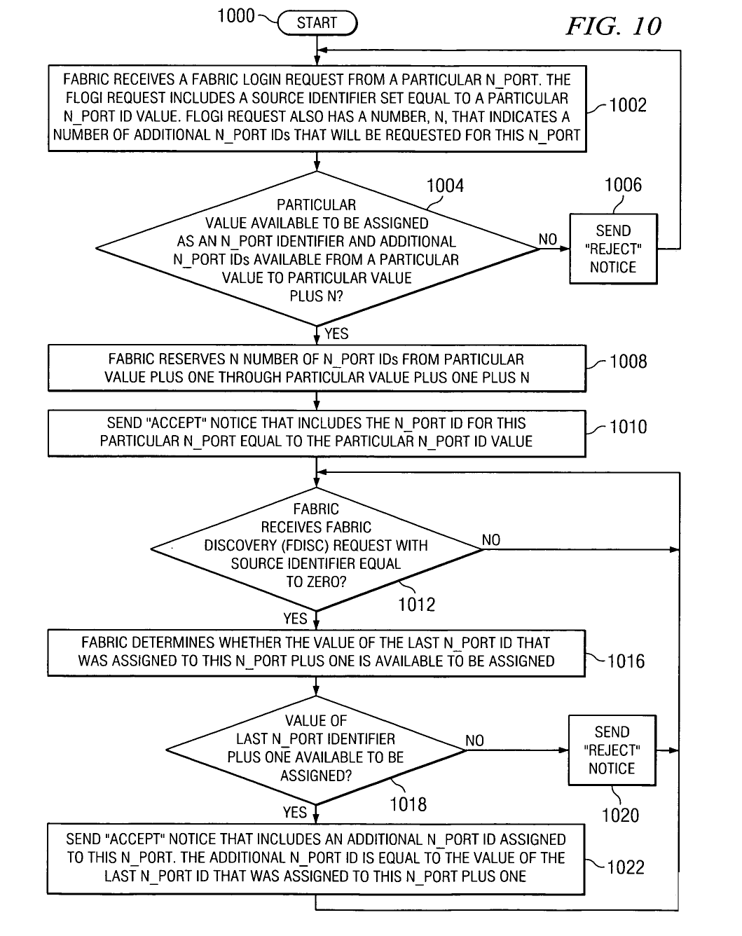

FIG. 10 depicts a high level flow chart that depicts the fabric granting a particular node identifier in response to a request, such as depicted by FIG. 9, and N number of additional deterministic virtual node identifiers in accordance with the present invention. The process starts as depicted by block 1000 and thereafter passes to block 1002 which depicts the fabric receiving a fabric login request (FLOGI) from a particular N_Port. The FLOGI request includes a source identifier that is set equal to a particular N_Port ID value. The FLOGI request also includes an indication of a number, “N”, that indicates the number of additional N_Port IDs that this N_Port will be requesting. Thus, N is the number of virtual N_Port IDs that will be requested.

Next, block 1004 illustrates a determination of whether or not the particular value indicated by the source identifier is available to be assigned as an N_Port ID, and whether additional N_Port IDs are available from the particular value through the particular value plus N. If a determination is made that the particular value indicated by the source identifier is not available to be assigned as an N_Port ID or additional N_Port IDs are not available from the particular value through the particular value plus N, the process passes to block 1006 which depicts sending a “reject” notice. The process then passes back to block 1002.

Referring again to block 1004, if a determination is made that the particular value indicated by the source identifier is available to be assigned as an N_Port ID value and that additional N_Port IDs are available from the particular value through the particular value plus N, the process passes to block 1008 which illustrates the fabric reserving N number of N_Port IDs from the particular value through the particular value plus N. Thereafter, block 1010 depicts sending an “accept” notice that includes an N_Port ID that has a value that is equal to the particular N_Port value.

Next, block 1012 illustrates a determination of whether or not the fabric has received a fabric discovery (FDISC) request having a source identifier set equal to zero. If a determination is made that the fabric has not received a fabric discovery (FDISC) request with its source identifier equal to zero, the process passes back to block 1012. Referring again to block 1012, if a determination is made that the fabric has received a fabric discovery (FDISC) request with its source identifier equal to zero, the process passes to block 1016 which depicts the fabric determining whether the value of the last N_Port ID that was assigned to this N_Port plus one is available to be assigned as the value of another N_Port ID.

Block 1018, then, illustrates a determination of whether or not the fabric is able to assign the last value of the N_Port ID plus one as the value of an additional N_Port ID to this N_Port. If a determination is made that the fabric is not able to assign the last value of the N_Port ID plus one as the value of another N_Port ID to this N_Port, the process passes to block 1020 which illustrates sending a reject notice. The process then passes to block 1012.

Referring again to block 1018, if a determination is made that the fabric is able to assign the last value of the N_Port ID plus one as the value of another N_Port ID to this N_Port, the process passes to block 1022 which illustrates the fabric sending an “accept” notice. The accept notice includes an additional N_Port ID that is equal to the last value of N_Port ID assigned to this N_Port plus one. The process then passes back to block 1012.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a communications network, including a communications network fabric that couples a plurality of nodes together, for requesting deterministic virtual address identifiers for one of said plurality of nodes, said method comprising:
requesting, by said one of said plurality of nodes, an assignment by said fabric of a particular value for a first node address identifier to be assigned to said one of said plurality of nodes;
requesting, by said one of said plurality of nodes, an assignment of a virtual node address identifier to said one of said plurality of nodes; and
assigning, by said fabric to said one of said plurality of nodes, a value for said virtual node address identifier, said value being deterministic and predictable by said one of said plurality of nodes before said value is assigned.

2. The method according to claim 1, further comprising:
said particular value being selected by said one of said plurality of nodes and not said fabric; and
after said assignment of said particular value, assigning, by said fabric, deterministic values for virtual node address identifiers assigned to said one of said plurality of nodes.

3. The method according to claim 1, further comprising:
assigning, by said fabric, said value for said virtual node address identifier, said value being equal to said particular value plus one.

4. The method according to claim 3, further comprising:
assigning, by said fabric, additional virtual node address identifiers to said one of said plurality of nodes, each one of said additional virtual node address identifiers being equal to a last virtual node address identifier that was assigned to said one of said plurality of nodes plus one, wherein said additional virtual node address identifiers are consecutive.

5. The method according to claim 1, further comprising:
specifying, by a user application, said particular value for said node address identifier for said one of said plurality of nodes in said user application;
specifying, by said user application for each one of a plurality of virtual node address identifiers for said one of said plurality of nodes, a particular value for said one of said plurality of virtual node address identifiers;
assigning, by said fabric, said particular value for said node address identifier; and
assigning, by said fabric for each one of said plurality of virtual node address identifiers for said one of said plurality of nodes, said particular value for said one of said plurality of virtual node address identifiers, wherein said user application chose said particular value for said node address identifier and, for each one of said plurality of virtual node address identifiers for said one of said plurality of nodes, said particular value for said one of said plurality of virtual node address identifiers prior to said fabric assigning any node address identifiers to said one of said plurality of nodes.

6. The method according to claim 1, further comprising:
said particular value being a first portion of a complete node address identifier;
selecting, by said fabric, a second portion of said complete node address identifier;
assigning, by said fabric, said complete node address identifier to said one of said plurality of nodes, said fabric selecting said second portion and said one of said plurality of nodes selecting said first portion of said complete node address identifier.

7. The method according to claim 6, further comprising:
assigning, by said fabric, said value for said virtual node address identifier, said value being equal to said particular value plus one.

8. The method according to claim 1, further comprising:
requesting, by said one of said plurality of nodes, an assignment of a particular number of a plurality of virtual node address identifiers; and
prior to said fabric assigning a value for any of said plurality of virtual node address identifiers, determining whether said plurality of virtual node address identifiers are available having a value of said particular value plus one through said particular value plus said particular number.

9. An apparatus in a communications network, including a communications network fabric that couples a plurality of nodes together, for requesting deterministic virtual address identifiers for one of said plurality of nodes, said apparatus comprising:
said one of said plurality of nodes requesting an assignment by said fabric of a particular value for a first node address identifier to be assigned to said one of said plurality of nodes;
said one of said plurality of nodes requesting an assignment of a virtual node address identifier to said one of said plurality of nodes; and
said fabric assigning to said one of said plurality of nodes a value for said virtual node address identifier, said value being deterministic and predictable by said one of said plurality of nodes before said value is assigned.

10. The apparatus according to claim 9, further comprising:
said particular value being selected by said one of said plurality of nodes and not said fabric; and
after said assignment of said particular value, said fabric assigning deterministic values for virtual node address identifiers assigned to said one of said plurality of nodes.

11. The apparatus according to claim 9, further comprising:
said fabric assigning said value for said virtual node address identifier, said value being equal to said particular value plus one.

12. The apparatus according to claim 11, further comprising:
said fabric assigning additional virtual node address identifiers to said one of said plurality of nodes, each one of said additional virtual node address identifiers being equal to a last virtual node address identifier that was assigned to said one of said plurality of nodes plus one, wherein said additional virtual node address identifiers are consecutive.

13. The apparatus according to claim 9, further comprising:
a user application specifying said particular value for said node address identifier for said one of said plurality of nodes in said user application;
said user application specifying, for each one of a plurality of virtual node address identifiers for said one of said plurality of nodes, a particular value for said one of said plurality of virtual node address identifiers;
said fabric assigning said particular value for said node address identifier; and
said fabric assigning, for each one of said plurality of virtual node address identifiers for said one of said plurality of nodes, said particular value for said one of said plurality of virtual node address identifiers, wherein said user application chose said particular value for said node address identifier and, for each one of said plurality of virtual node address identifiers for said one of said plurality of nodes, said particular value for said one of said plurality of virtual node address identifiers prior to said fabric assigning any node address identifiers to said one of said plurality of nodes.

14. The apparatus according to claim 9, further comprising:
said particular value being a first portion of a complete node address identifier;
said fabric selecting a second portion of said complete node address identifier;
said fabric assigning said complete node address identifier to said one of said plurality of nodes, said fabric selecting said second portion and said one of said plurality of nodes selecting said first portion of said complete node address identifier.

15. The apparatus according to claim 14, further comprising:
said fabric assigning said value for said virtual node address identifier, said value being equal to said particular value plus one.

16. The apparatus according to claim 9, further comprising:
said one of said plurality of nodes requesting an assignment of a particular number of a plurality of virtual node address identifiers; and
prior to said fabric assigning a value for any of said plurality of virtual node address identifiers, said fabric determining whether said plurality of virtual node address identifiers are available having a value of said particular value plus one through said particular value plus said particular number.

17. A computer program product comprising:
a computer usable medium including computer usable program code for requesting deterministic virtual address identifiers for one of a plurality of nodes in a communications network including;
said communications network including a communications network fabric that couples said plurality of nodes together;
computer usable program code for requesting, by said one of said plurality of nodes, an assignment by said fabric of a particular value for a first node address identifier to be assigned to said one of said plurality of nodes;
computer usable program code for requesting, by said one of said plurality of nodes, an assignment of a virtual node address identifier to said one of said plurality of nodes; and
computer usable program code for assigning, by said fabric to said one of said plurality of nodes, a value for said virtual node address identifier, said value being deterministic and predictable by said one of said plurality of nodes before said value is assigned.

18. The product according to claim 17, further comprising:
said particular value being selected by said one of said plurality of nodes and not said fabric; and
after said assignment of said particular value, computer usable program code for assigning, by said fabric, deterministic values for virtual node address identifiers assigned to said one of said plurality of nodes.

19. The product according to claim 17, further comprising:
computer usable program code for assigning, by said fabric, said value for said virtual node address identifier, said value being equal to said particular value plus one.

20. The product according to claim 19, further comprising:
computer usable program code for assigning, by said fabric, additional virtual node address identifiers to said one of said plurality of nodes, each one of said additional virtual node address identifiers being equal to a last virtual node address identifier that was assigned to said one of said plurality of nodes plus one, wherein said additional virtual node address identifiers are consecutive.
